(19) United States
(12) Patent Application Publication
(10) Pub. No.: US 2011/0143785 A1
(43) Pub. Date: Jun. 16, 2011

(54) Phone Power Adapter for Car with GPS Tracking and Auto-Upload

(76) Inventors: Meir S. Cohen, Toms River, NJ (US); Eli Finkelman, Toms River, NJ (US)

(21) Appl. No.: 12/638,232

(22) Filed: Dec. 15, 2009

(51) Int. Cl. H04W 4/12; G01S 19/13; H02J 7/00

(52) U.S. Cl. 455/466; 320/107; 320/114

(57) ABSTRACT

Disclosed herein are embodiments of a power adapter, adapted for electrical engagement with a power outlet found in a cabin of a vehicle and with a device to be powered. The adapter further comprises a satellite receiver to receive data used to determine position (e.g. GPS) and logs such data. Upon obtaining network connectivity through either a network adapter in the device or a network connection of the device to be powered, such logged data is uploaded to a remote location. Video, audio, or other data may also be logged and uploaded.

### FIELD OF THE DISCLOSED TECHNOLOGY

The disclosed technology relates generally to phone chargers and more specifically, to phone chargers for placement in vehicles.

### BACKGROUND OF THE DISCLOSED TECHNOLOGY

In-car GPS (global positioning system or other satellite navigation technology) is known in the art, as are GPS loggers. In summary, based on a signal received from satellites revolving around the earth at known positions, the location of a receiver of such signals may be determined. Such location data may also be logged. GPS logging devices, such as those placed beneath a car, enable a user (or law enforcement agent) to track the location of a vehicle. In many such embodiments, the device has to be retrieved and the data downloaded. In other embodiments, the device has network connectivity and is a GPS tracker. GPS trackers enable offsite monitoring of the location of a vehicle in real time.

While GPS loggers and GPS trackers have their uses, obvious downsides to each exist. GPS loggers do not provide real time data. Data can only be retrieved, such as by a third party, after the device itself is retrieved or accessed. This requires “manual labor” in that a person must take further action which may even involve getting beneath the vehicle again to retrieve the GPS logger. Needless to say, when tracking criminal activity, the least number of times one must access the vehicle, the better. Further, if data are required more frequently than it is possible or convenient to access the GPS logger device, it must be done by way of a GPS tracker.

GPS trackers, too. have their drawbacks. GPS trackers require network connectivity which is not always easy to come by and may be expensive. For example, a GPS tracker may need its own connection to a cellular data network or a special license to operate on another frequency. The cost of power consumption for handling GPS tracking, storage, and constant or near-constant long range radio transmission, may also be prohibitive. The cost of such devices is also much higher than GPS loggers.

Still another problem exists of detection when either a GPS logger or tracker is used. The device may be undesiredly discovered and the purpose of its use compromised. A suspected criminal under surveillance may discover the device, disable it, and take new measures to avoid law enforcement. A parent attempting to track the driving habits of his minor child also may need to hide his or her activities in GPS logging. Further, a person may make use of GPS tracking to find the location of his or her car in case it is stolen or misused by someone who has borrowed the car. In all of these cases, detection would likely put an the end to the legal owner's being able to retrieve the data sought.

Thus, the prior art leaves room for improvement upon current tracking technologies. What is needed is a way to track movements of a vehicle incognito, i.e., with the least amount of physical intervention possible by the person placing such a device. A further need in the art is to have a way to track a position of a vehicle cheaply, that is, without requiring expensive or obscure network connectivity solutions, and with power consumption as low as possible.

### SUMMARY OF THE DISCLOSED TECHNOLOGY

It is therefore an object of the disclosed technology to disguise a GPS logging or tracking device in a vehicle.

It is a further object of the disclosed technology, to combine GPS logging and tracking features with existing devices.

It is a still further object of the disclosed technology to use existing networks of devices within a car to send GPS information to a remote location.

It is yet another object of the disclosed technology to seek out available wireless networks to send GPS information to a remote location.

A device of embodiments of the disclosed technology comprises an adapter with a first electrical interface adapted for engagement with an in-vehicle power outlet, such as a 12 volt outlet used traditionally as a cigarette lighter, or any other specialized port within the cabin of a car or other vehicle designed for providing electrical current to a portable device used within the vehicle. A second electrical interface of the device (adapter) is adapted for engagement with a handheld wireless cellular device, such as a cellular telephone, personal digital assistant, or the like having connectivity with a cellular network. A global navigation satellite system receiver is also within the device, such as a global positioning system (GPS) receiver configured to receive GPS satellite signals from at least four satellites and determine a present position of the device. A data storage device configured for storage of received global navigation system data from the global navigation satellite system is also part of the device. Thus, the device functions, for example, as a cellular phone charger and GPS logger. The device may further provide an electrical current through the second electrical interface to charge a battery in the handheld wireless cellular device.

In an embodiment of the disclosed technology, the device may have a wireless network adapter, that is, an adapter capable of sending, receiving, and interpreting data signals transmitted wirelessly to a network, such as an at home network and/or 802.11 wireless network (e.g., 802.11a, 802.11b, 802.11g, or 802.11n according to the standards drafted by the IEEE LAN/MAN standards committee and widely known in the art). Such a wireless network adapter may be configured to seek out available wireless networks and send data stored in the data storage device (e.g., coordinates mapped over time or video/audio data) to a remote server upon connection to the wireless network. Such networks may be either unsecured networks and/or networks preprogrammed into the device, such as via configuration before placement into the vehicle.

In another embodiment of the disclosed technology, the wireless cellular device may have connectivity with a cellular network and data stored on the data storage device is uploaded, at least in part, via the cellular network (e.g., through the wireless cellular device) to a remote server. A data connection may be sought with the server via a network adapter in the device and a network adapter in the wireless cellular device and, upon establishing network connectivity via either route, the data stored on the data storage device is uploaded to the server.

In yet another embodiment of the disclosed technology, the device (adapter) may further have at least one sensory input device configured to record sensory information to the data storage device. That is, a microphone to record sound, a camera to record video, and/or a thermometer to record the temperature may be employed in the device, and such data may further be uploaded via a network to the server upon obtaining network connectivity.

A method for charging a battery in a handheld wireless device and logging position data is also disclosed. The method is carried out by electrically engaging an adapter with a power outlet provided in a cabin of a vehicle (such as described above with reference to the device), electrically engaging the adapter with a power receiving outlet provided in the handheld wireless device, and receiving global navigation satellite data while storing the data on a data storage device located within the adapter. The device may provide an electrical current through the power receiving outlet to charge a battery in the handheld wireless device.

The adapter may further have a wireless network adapter and, in an additional step of the method, it may be configured to seek out an available wireless network and send data stored in the data storage device to a remote server upon connection to the wireless network. This may include seeking out unsecured (e.g., open, unencrypted, public access) 802.11 wireless networks, only wireless networks preprogrammed in the device, and the like.

In another embodiment, the method may proceed by uploading data stored on the data storage device to a server through a data connection between the handheld wireless device and a cellular network. That is, the adapter may “piggyback” off the network of the cellular device, e.g., a cellular phone network. Still further, this may be combined with the usage of a wireless network adapter within the adapter. That is, either the built-in wireless network adapter of the adapter or a cellular network associated with the handheld wireless device may be used, whichever is available, to upload at least some data from the data storage device to the server upon establishing a data connection from the adapter to a wireless network.

In the method of carrying out the disclosed technology, a step of receiving data from a sensory input device and storing the data on the data storage device may take place. Again, the sensory input device may be a microphone, camera, thermometer, or the like.

### BRIEF DESCRIPTION OF THE DRAWINGS

FIG. 1 shows a high level drawing of a vehicle dashboard with power outlet, charger and handheld wireless device of the prior art.

FIG. 2 shows a high level drawing of a global navigation system and 802.11 network devices used in embodiments of the disclosed technology.

FIG. 3 shows a high level drawing of global navigation system and cellular network devices used in embodiments of the disclosed technology.

FIG. 4 shows a high level schematic diagram of devices within the adapter in an embodiment of the disclosed technology.

FIG. 5 shows a high level power diagram of an adapter device in an embodiment of the disclosed technology.

FIG. 6 shows a top plan view of an adapter of an embodiment of the disclosed technology.

FIG. 7 shows a bottom plan view of an adapter of an embodiment of the disclosed technology.

FIG. 8 is a flow chart of a method of carrying out embodiments of the disclosed technology relative to an adapter.

FIG. 9 shows a high-level block diagram of a device that may be used to carry out the disclosed technology.

### DETAILED DESCRIPTION OF EMBODIMENTS OF THE DISCLOSED TECHNOLOGY

Embodiments of the disclosed technology comprise a power adapter (herein, “adapter”), adapted for electrical engagement with a power outlet found in a cabin of a vehicle and with a device to be powered. The adapter further comprises a satellite receiver to receive data used to determine position (e.g., GPS) and logs such data. Upon obtaining network connectivity through either a network adapter in the device or a network connection of the device to be powered, such logged data is uploaded to a remote location. Video, audio, or other data may also be logged and uploaded.

Embodiments of the disclosed technology are described below, with reference to the figures provided.

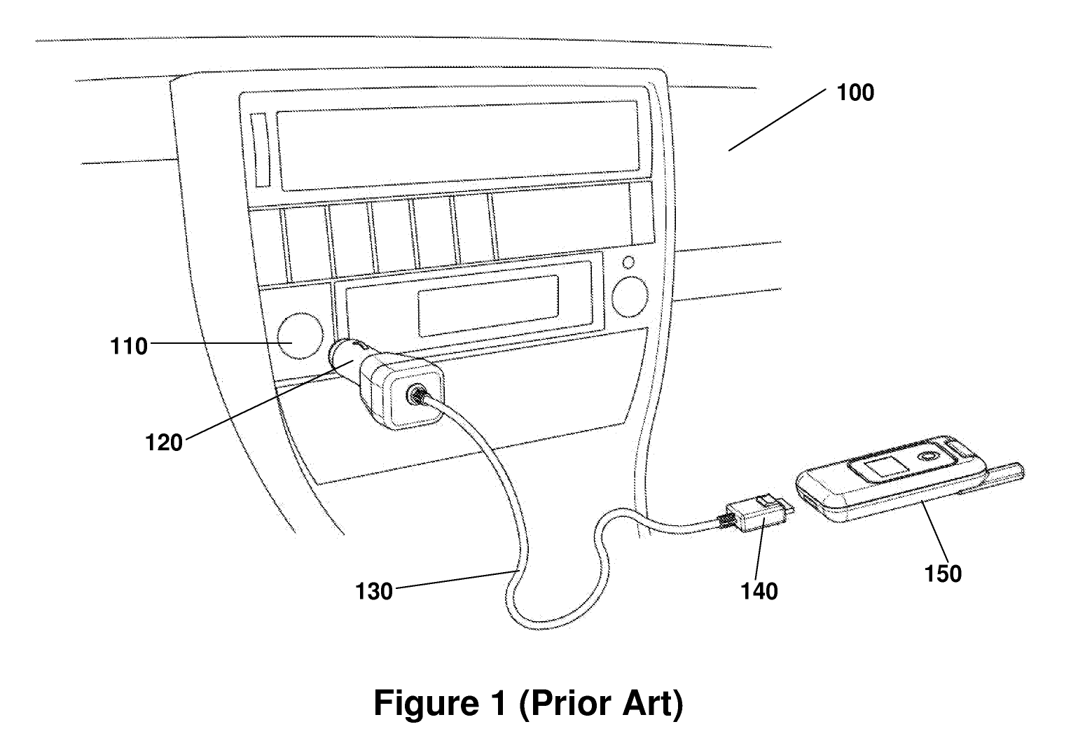

FIG. 1 shows a high level drawing of a vehicle dashboard with power outlet, charger and handheld wireless device of the prior art. Such devices are used in embodiments of the disclosed technology, though the charger 120 is modified in embodiments of the disclosed technology. The dashboard 100 (or any other area of the vehicle cabin) comprises a power outlet 110 which may be of the type which is standard in vehicles and formerly used for a cigarette lighter function. The power outlet 110 may be specifically adapted for use with a handheld wireless device, such as a power outlet for an Apple Corporation iPhone, MP3 player, or the like. A charger or adapter 120 electrically interfaces with the power outlet 110 and changes the input current, typically approximately 12 volt direct current or 13.7 volt direct current provided by the car/vehicle battery to a voltage and current needed to power a handheld wireless device, such as a cellular phone 150, via a connecting wire 130 and electrical interface 140. In this manner, a user may plug a cellular phone 150 (or other device such as a handheld wireless or electrically operated device) into the electrical interface 140, that is, an interface designed for a specific cellular phone or other wireless device, and power/charge the device using the adapter 120 which electrically engages or interfaces with the power outlet 110.

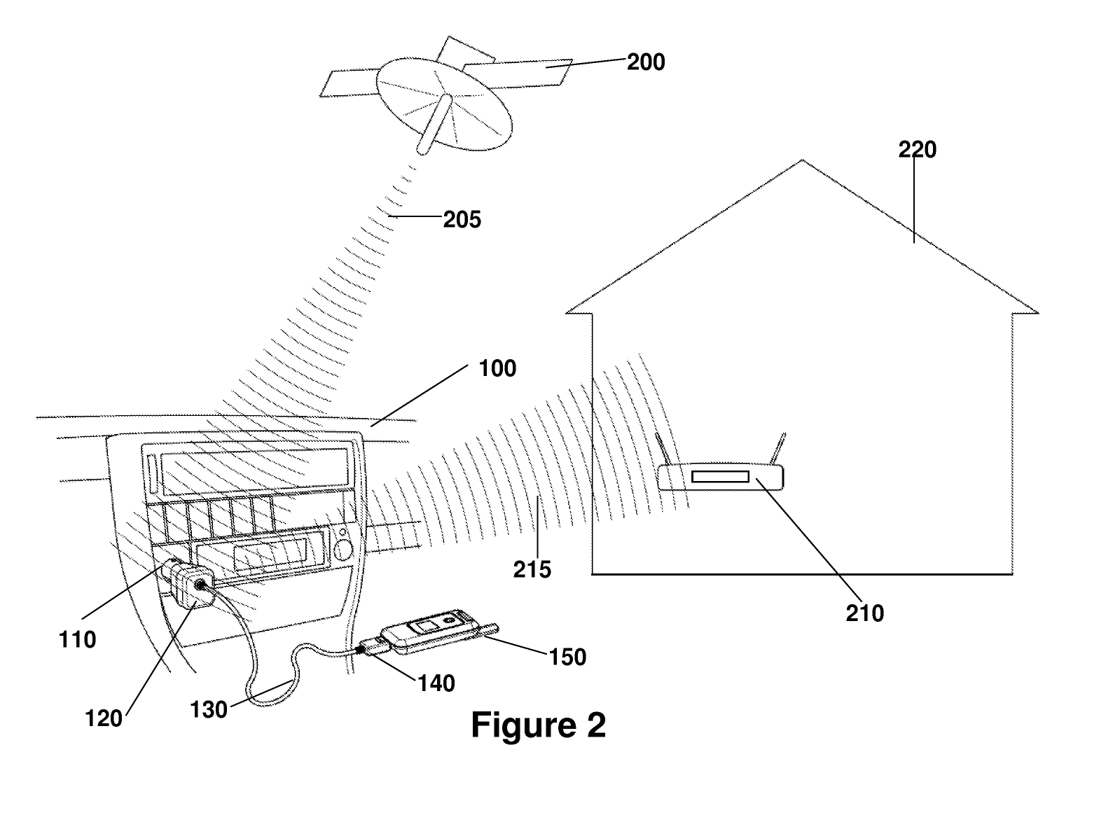

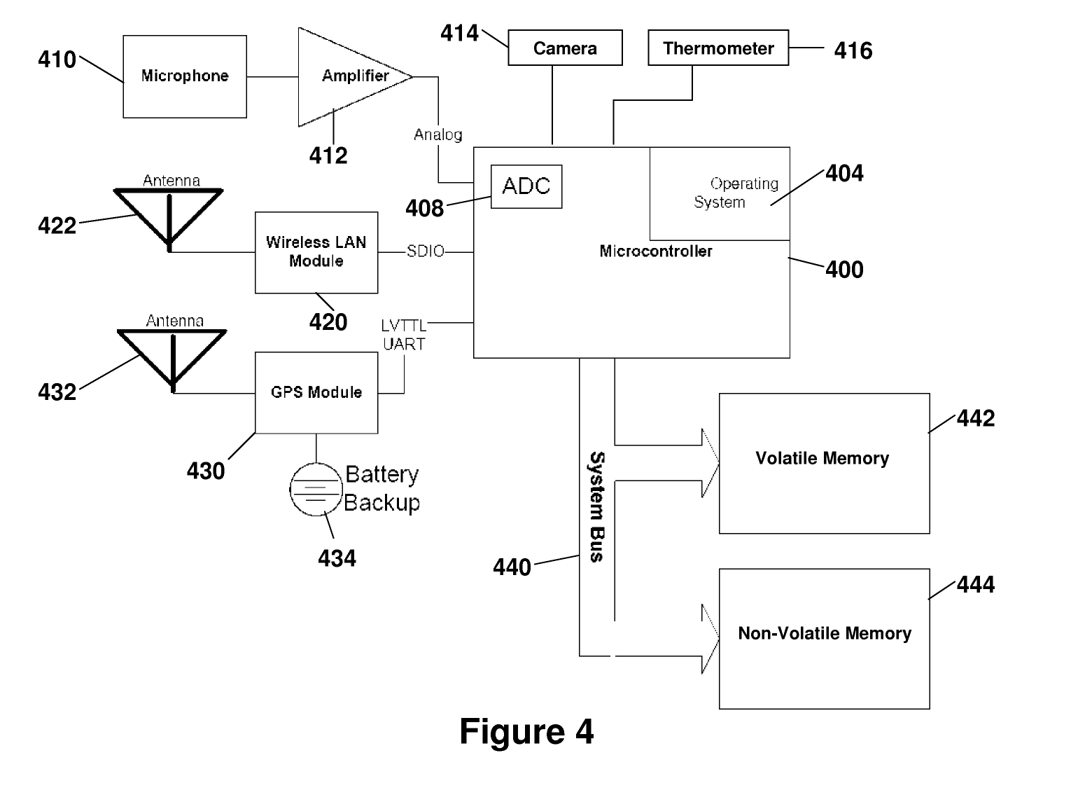

FIG. 2 shows a high level drawing of a global navigation system and 802.11 network devices used in embodiments of the disclosed technology. Where applicable, the same numbers for elements of FIG. 2 are shared with those described in FIG. 1. A plurality of satellites 200 (only one is shown in FIG. 2), as is known in the art, revolve around the earth and provide location data. Such global navigation systems include the United States Army-funded Global Positioning System (GPS), GLONASS in Russia, Galileo in Europe, and so forth. The adapter 120 comprises a global navigation system receiver capable of receiving a navigation signal 205 from a plurality of navigation satellites 200 and determining the position of the device relative to the earth. Such navigation data and/or a relative position of the device are stored on a storage medium within the adapter 120 and/or handheld wireless device, such as cellular phone 150 (see FIG. 4).

In the embodiment shown in FIG. 2, a wireless router 210, such as an (IEEE) 802.11 specification wireless router is situated inside a building 220, such as a house, office building, free standing wireless access point, or other structure. It should be understood that the wireless router 210 may be used and may be at any location. The wireless router may use substantially any wireless communication schema known in the art, including Bluetooth, 802.11a, 802.11b, 802.11g, 802.11n, WiMAX, Wireless USB, or the like. The adapter 110 comprises a wireless adapter corresponding to the specific protocol/specification capable of connecting to such a network. In one embodiment, the wireless adapter actively seeks out a data connection with a specific wireless router 210. In another embodiment, the adapter actively seeking out is dependent upon a location determined based on the navigation data (e.g., when near the owner's home, attempt to connect to a first wireless router, or when in a pre-specified city, attempt to connect to a second wireless router or group thereof), or other pre-programmed data. In yet another embodiment, which may be separate or combined with the prior embodiments, an attempt is made to connect with any open wireless network.

Upon obtaining a wireless connection (negotiating a data connection between a wireless adapter within adapter 120 and a wireless router 210), data stored in a storage medium within the adapter 120 is uploaded to a remote server via the data connection. In this manner, position data is logged, e.g., position data at specific times, and uploaded only as a connection becomes available. In addition, a camera, microphone, or thermometer may interface or form an integral part of the adapter (in-car charger) so as to allow the adapter to store video, audio, and thermal data as a function of time. Thus, any one, or a plurality, of position, video, audio, and temperature data as a function of time is uploaded to a remote server upon obtaining a wireless data connection between the adapter 120 and a network, such as the internet, via wireless router 210.

In this manner, a consistent data connection is not necessary, the cost to track vehicle data is greatly reduced, and it is done in a manner which is convenient for the user without requiring protection from the elements and/or a separate power source when using exterior or other interior equipment, and so forth. The feeling of invasiveness is also decreased over prior art navigation logging devices. Still further, in uses of the disclosed technology such as after an auto theft, GPS receiver theft, handheld wireless device theft, or other theft, the thief is unlikely to realize that his position, and possibly picture, sound, and when a car door is opened/closed (due to perceivable temperature change) is being recorded and sent to a remote server.

In a further method of use of the devices of FIG. 2, a person may use such a device for recreational monitoring of the location and other data related to his vehicle, without requiring a power splitter to plug in two devices, and so forth. Additionally, a parent may use such a device to monitor the driving habits of a teen driver or ensure compliance with coming home at a designated curfew or avoiding a certain location. In such an example, upon the car pulling into the driveway or garage of the owner, the adapter 120 and wireless adapter within it may come into range of a wireless router 210 and thus, via wireless transmit signal 215, data stored on a storage medium within the adapter 210 is uploaded to a computer of a parent. The parent can then review such data. The teen driver may be aware or unaware that the adapter 210 is logging.

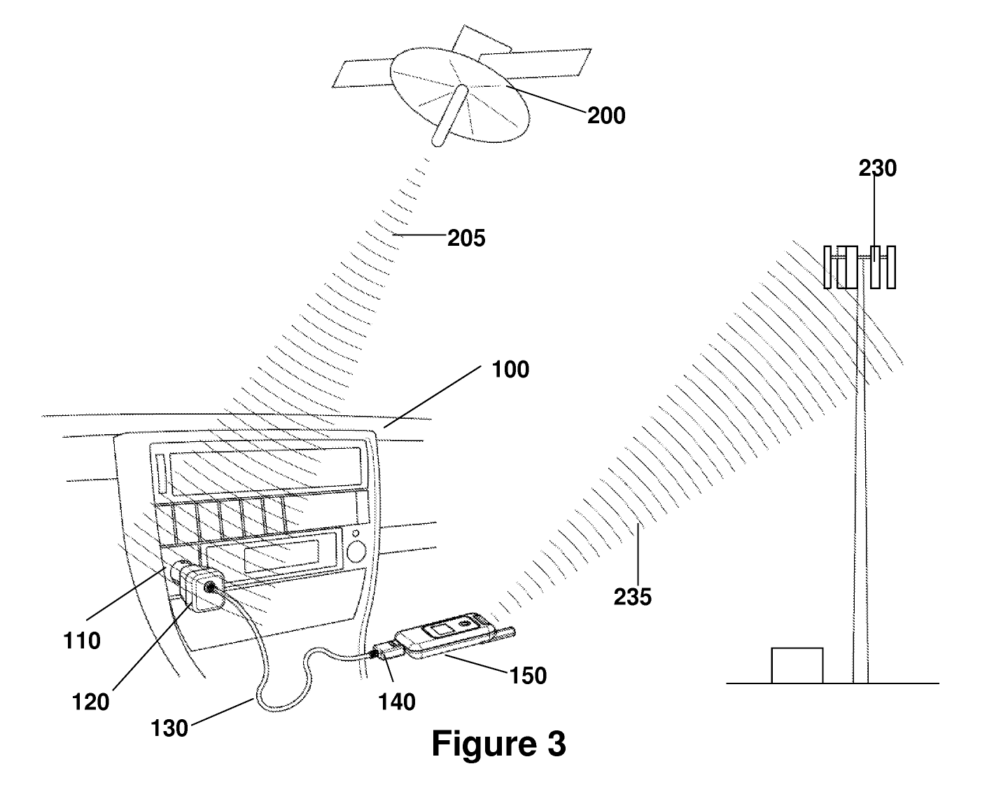

FIG. 3 shows a high level drawing of a global navigation system and cellular network devices used in embodiments of the disclosed technology. Where possible, label numbers for elements shown in FIGS. 1 and 2 are maintained in FIG. 3. A cellular network is one example of network connectivity of a device to be charged or powered by the adapter. In the embodiment shown in FIG. 3, a data connection between the adapter 120 and cellular phone 150 (or any other handheld wireless device) is obtained via the power outlet 140, whereby both electrical current used to power/charge device 150 and data are exchanged. The storage medium, that is, a device which stores location and other data garnered by the adapter 120, may be located within the adapter 120, within the cellular phone 150, or both. The cellular phone 150 obtains cellular network connectivity (shown as transmit signal 235) with a cellular tower 230. It should be understood that in embodiments of the disclosed technology, any wireless network may be obtained by a device 150 and used to transmit data stored on a storage medium comprising location or other data (see FIG. 2) to a remote location via such a wireless data connection.

It should be understood that in embodiments of the disclosed technology, the handheld wireless device may be a cellular phone (as shown and described above), or any other handheld device which interfaces with a charger, such as an in-car charger which receives electric current from within the cabin of a vehicle. For example, the adapter may be used to power a separate satellite navigation device, ambulance equipment (lights, sirens), a CB or amateur radio, a laptop computer, and so forth. Such devices may have network connectivity in the form of receiving or sending a signal, such as via an analog or digital network.

FIG. 4 shows a high level schematic diagram of devices within the adapter in an embodiment of the disclosed technology. Various sensory devices (one or a plurality of) are used in embodiments of the disclosed technology, including, for example, a microphone 410 operatively (electrically) connected to an amplifier 412, a camera or other video input 414, and a thermometer 416. These devices electronically interface with and are operatively connected to a central controller or logic circuits of an adapter device, such as a microcontroller 400 running an operating system 404 with an analog-to-digital converter (ADC) 408. The analog-to-digital converter converts a signal received from the microphone 410, or any other analog device, and converts the signal, such as a signal representing recorded sound, into a digital signal for storage on a storage device, such as the volatile memory 442 and/or non-volatile memory 444. The operating system 404 may be any operating system known in the art of microcontrollers, such as Linux and variants thereof. The microcontroller 400, in embodiments of the disclosed technology, is a single integrated circuit having a central processing unit (CPU) combined with support functions, such as a crystal oscillator, timers, watchdog timer, serial and analog I/O or the like. Via a system bus 440, the microcontroller accesses any one or both of volatile memory 442, such as random access memory (RAM) and non-volatile memory (e.g., magnetic disk, flash disk) 444.

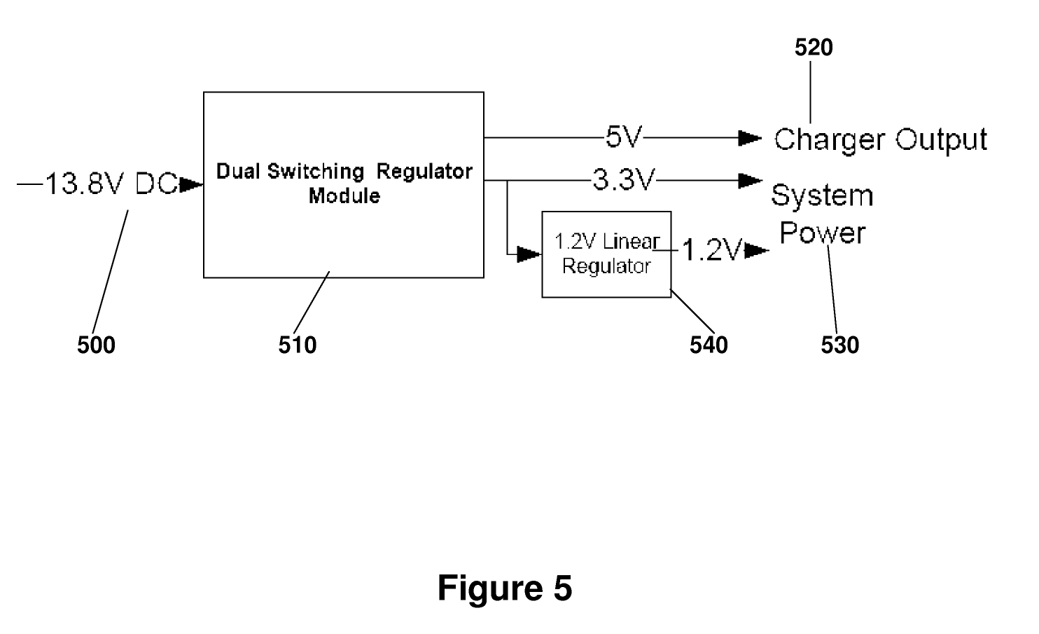

Referring still to FIG. 4, an antenna 422 is operatively engaged with a wireless LAN module 420 in embodiments of the disclosed technology. The wireless LAN module is an example of a wireless adapter which can be configured to connect to a wireless network, such as any available wireless network or a specific wireless network. This includes 802.11 networks, Bluetooth networks, wireless USB networks, and so forth, as described above. (As shown in the example of FIG. 4, the wireless LAN module is part of an SDIO (secure digital input output) card which also comprises flash memory.) It is via the wireless LAN module 420 or any other wireless adapter that, in embodiments of the disclosed technology, stored data, such as navigation (location) data, recorded sounds from the microphone 410, recorded pictures or video from the camera 414, and so forth are uploaded to a remote server, such as a personal computer of an owner or operator of the adapter device. In other embodiments of the disclosed technology, such data is uploaded through a network associated with the wireless handheld device, such as a cellular phone or device with cellular network capabilities (see FIG. 5).

Still referring to FIG. 4, a GPS module 430 is an example of a satellite navigation system receiver and processor connected to an antenna 432 and having the ability to determine its location based on received satellite data signals. The GPS module 430 (or any other satellite navigation system receiving device), in embodiments of the disclosed technology, is operatively connected to a battery backup 434. The battery backup 434 may be charged when the adapter receives a flow of electric current from a vehicle battery (e.g., when engaged with a power outlet 110). Thus, even when the adapter is not plugged in, position data can continue to be accrued and then uploaded the next time the adapter receives full power (e.g., is engaged with a power outlet 110) and connects with a wireless router via the wireless network adapter 420 or a connection to a network associated with a handheld wireless device, such as a cellular network. The backup battery 434, in an embodiment, gives power to the GPS module 430 or other navigation system receiving equipment, to the exclusion of other devices shown and described in FIG. 4. In another embodiment, it powers the GPS module 430 and microcontroller 400. In yet another embodiment, it powers the GPS module 430 and microcontroller 400. In yet another embodiment, it powers all but the sensory devices (microphone, camera, and thermometer, as shown in FIG. 4) and their specialized equipment (e.g., amplifier). In yet another embodiment, the battery backup 434 powers, part or all of the time, the adapter device in its entirety with the exception of a power output/outlet to a handheld wireless device. As such, various power savings modes are available to allow for minimal or maximal data acquisition when input power is unavailable.

FIG. 5 shows a high level power diagram of an adapter device in an embodiment of the disclosed technology. An input electrical interface, such as an interface between device 110 and 120 (see FIG. 1) provides current, such as 13.8 volt DC power 500 as is known in the art of cabin vehicle power outlets. A dual switching regulator module 510 converts the input power into voltages needed to both operate the adapter and devices therein, as well as provides power to a handheld wireless device for operation and charging thereof. In this example, the outputs of the dual switching regulator module 510 include a 5 volt output to an electrical interface adapted for engagement with a handheld wireless device 520, a 3.3 volt output to power devices within the adapter (since such devices may have lower power requirements than a handheld wireless device), and a further 1.2 volt linear regulator 540 with 1.2 volt output for a battery backup and GPS module or other devices within the adapter. This lower power requirement of the GPS module allows its operation to continue for a long period of time due to its lower power consumption compared to the rest of the devices within the adapter.

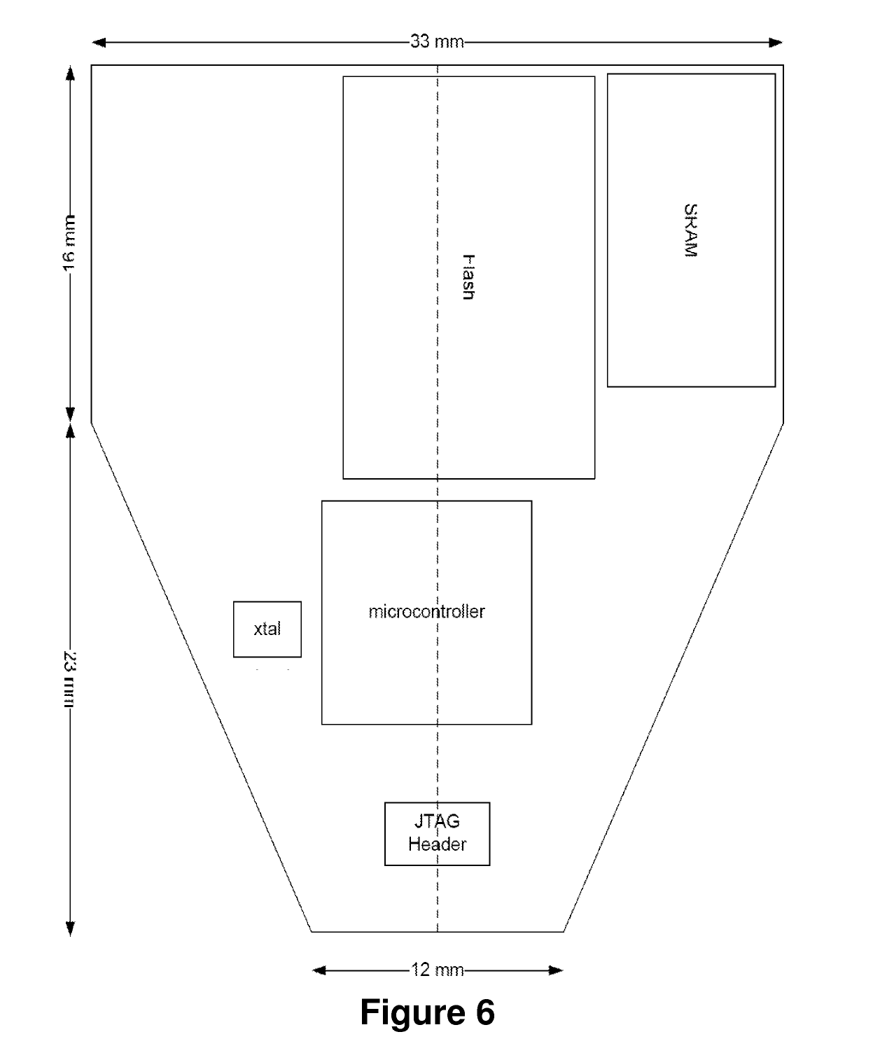

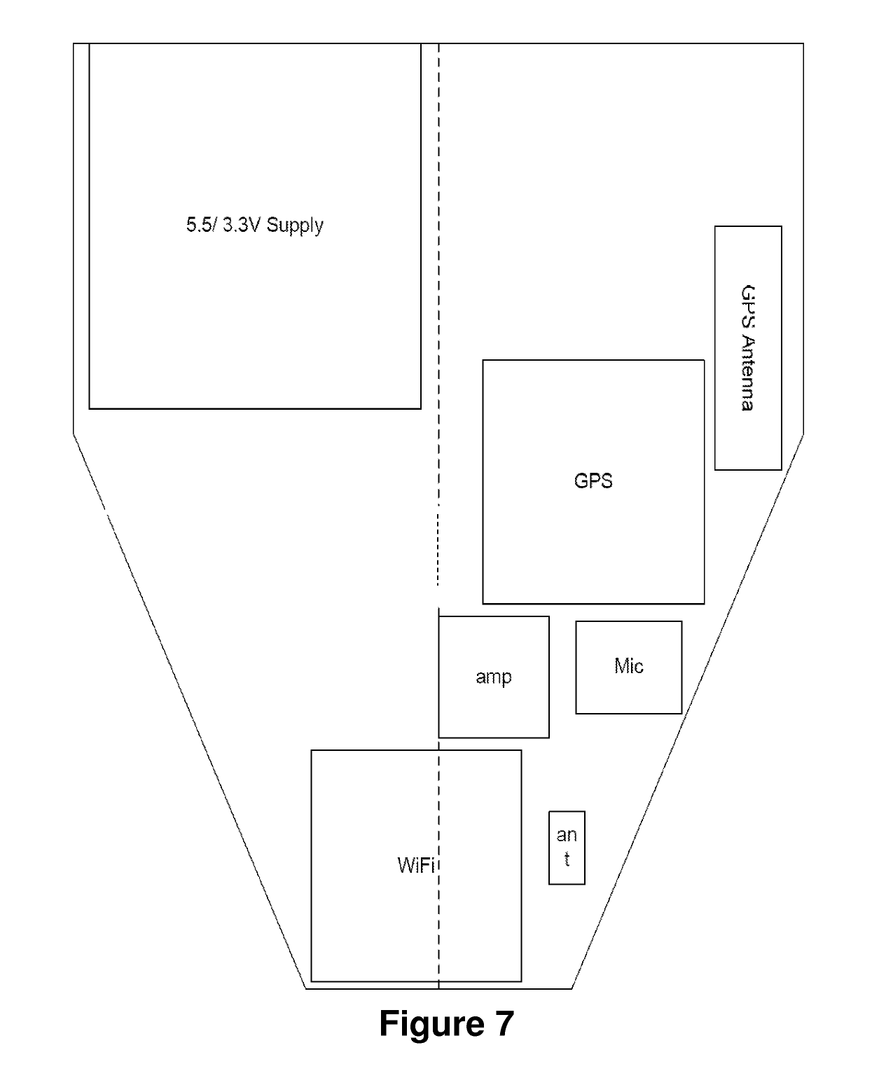

FIG. 6 shows a top plan view of an adapter of an embodiment of the disclosed technology. FIG. 7 shows a bottom plan view of an adapter of an embodiment of the disclosed technology. The dimensions here are 33 mm at the top, 16 mm at the bottom, with the length of the top section being 16 mm and the length of the bottom section being 23 mm. The 16 mm width is an approximate width necessary to electrically interface with an in-car power outlet. The dimensions, in embodiments of the disclosed technology, may vary, for example, to mimic the shape and size of a charger for a specific handheld wireless device and/or to be adapted for use with various power outlets.

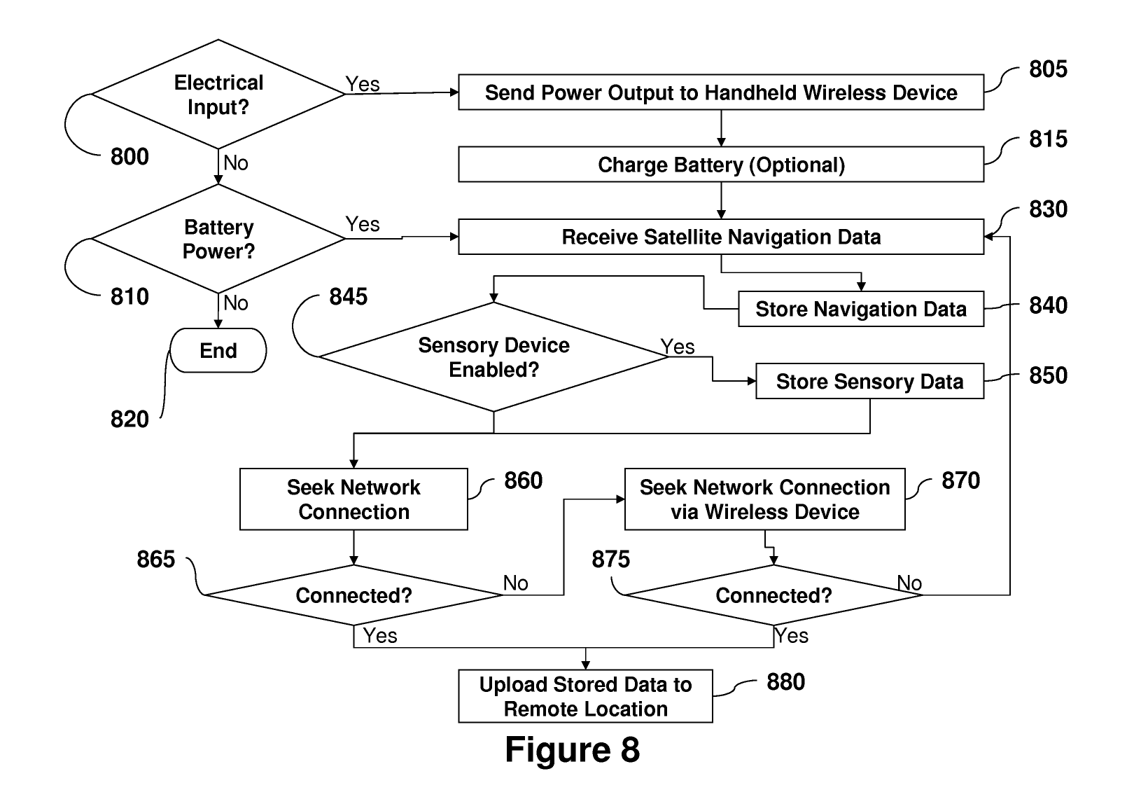

FIG. 8 is a flow chart of a method of carrying out embodiments of the disclosed technology relative to an adapter. In step 800, it is determined whether the adapter has an electrical input. That is, it is determined whether the device is receiving enough electric current to operate on this current. If not, it is determined whether there is (enough) battery power, in step 810, to operate at least the satellite navigation system receiving devices (or any subset of devices of the adapter). If there is not enough current for this, the system goes into a shutdown mode whereby. in step 820, the device powers down. Once there is an electrical input again, the device powers back on. When the electric input is removed, the cycle repeats, regardless of the stage on the flow chart which is currently being carried out.

When there is an electrical input (e.g., 12-14 volts of DC, step 805 is carried out whereby power is outputted to a handheld wireless device or other electrical device, such as in the form of 5 volt DC current. In embodiments where the adapter is configured with a battery, in step 815, the battery is charged. If it is fully charged, this step is bypassed. In step 830, satellite navigation system data (e.g., GPS data) is received and a location of the adapter relative to the earth is discovered (concurrently or via post-processing). The navigation data is then stored, in step 840, on a storage device shown and described with reference to the device-related figures.

In step 845, it is determined whether sensory devices are enabled. They may or may not be enabled due to configuration of a user (e.g., lower power and lower storage requirements without video), configuration of the adapter itself (e.g., the adapter may lack a camera to lower cost of procurement), power state of the device (e.g., when operating on battery power, the camera may be disabled), or for any other reason (e.g., malfunction of a sensory device). For each enabled sensory device, e.g., camera, microphone, or thermometer, in step 850, after the data is received, it is stored. Steps 800 to 850, in embodiments of the disclosed technology, occur substantially concurrently (whereby ‘substantially’ is defined as within five seconds of each other or as fast as the adapter is able to process same under its current load).

Step 860 and 870 may occur in any order and may occur repeatedly and concurrently with any of the prior steps. In step 860, a connection to a wireless network, such as an 802.11 network, is sought, using, for example, a wireless network adapter built into the device itself. If a connection is made, then step 880 is carried out, whereby the data which has been stored is uploaded to a remote location, such as a computer of the owner on the internet or a server operated by the manufacturer of the device or third party, whereby law enforcement agencies or the owner of the device receive and can view the data. Uploading stored data is defined as a transfer or attempt to transfer at least some of the data stored on a storage device within the adapter, or an attached handheld wireless cellular or other device via a network connection.

Steps 870 and 875 are similar to steps 860 and 865, except that the connection is to a network of an attached wireless device, such as a cellular network. Thus, referring back to FIG. 3, the data stored on a storage medium within the adapter device, in embodiments of the disclosed technology, is sent through the electrically engaged wireless/handheld device for which the adapter is providing power to a network. Where, for example, the network connection associated with the adapter in step 860 is an 802.11 wireless network and the network connection associated with a device powered by the adapter in step 870 is a cellular network, one or the other connection may be favored, and where either network connection is available, stored data is uploaded.

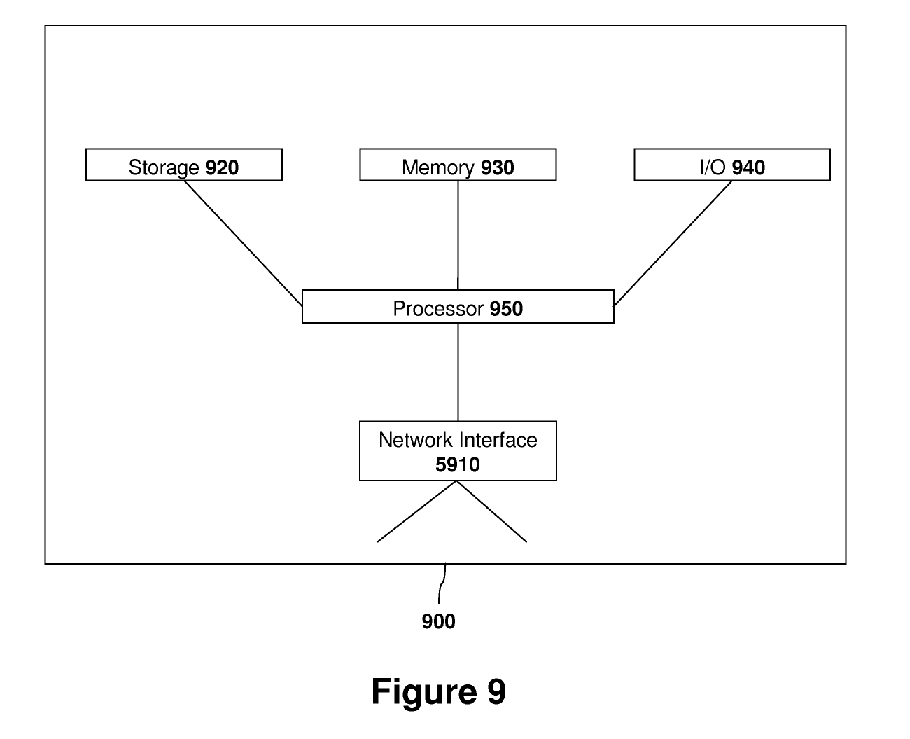

FIG. 9 shows a high-level block diagram of a device that may be used to carry out the disclosed technology. Device 900 comprises a processor 950 that controls the overall operation of the computer by executing the device's program instructions which define such operation. The device's program instructions may be stored in a storage device 920 (e.g., magnetic disk, database) and loaded into memory 930 when execution of the console's program instructions is desired. Thus, the device's operation will be defined by the device's program instructions stored in memory 930 and/or storage 920, and the console will be controlled by processor 950 executing the console's program instructions. A device 900 also includes one or a plurality of input network interfaces for communicating with other devices via a network (e.g., the internet). A device 900 also includes one or more output network interfaces 910 for communicating with other devices. Device 900 also includes input/output 940 representing devices which allow for user interaction with a computer (e.g., display, keyboard, mouse, speakers, buttons, etc.). One skilled in the art will recognize that an implementation of an actual device will contain other components as well, and that FIG. 9 is a high level representation of some of the components of such a device for illustrative purposes. It should also be understood by one skilled in the art that the method and devices depicted in FIGS. 1 through 8 may be implemented on a device such as is shown in FIG. 9.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

I claim:

1. A device comprising:
a first electrical interface adapted for engagement with an in-vehicle power outlet;
a second electrical interface adapted for engagement with a handheld electrical device comprising network connectivity;
a global navigation satellite system receiver;
a data storage device configured for storage of received global navigation system data from said global navigation satellite system receiver.

2. The device of claim 1, wherein said device provides an electrical current through said second electrical interface to charge a battery in said handheld electrical device.

3. The device of claim 1, further comprising a wireless network adapter.

4. The device of claim 3, wherein said wireless network adapter is configured to seek out an available wireless network and upload data stored in said data storage device to a remote server upon connection to said wireless network.

5. The device of claim 4, wherein said seeking out of said available wireless network comprises seeking out of unsecured 802.11 wireless networks.

6. The device of claim 4, wherein said seeking out of said available wireless network comprises seeking out of only wireless devices pre-programmed into said device.

7. The device of claim 2, wherein said wireless cellular device comprises connectivity with a cellular network and data stored on said data storage device is uploaded, at least in part, through said wireless cellular device and via said cellular network to a remote server.

8. The device of claim 7, wherein a data connection is sought with said server via a network adapter in said device and a network adapter in said wireless cellular device and upon establishing network connectivity, said data stored on said data storage device is uploaded to said server.

9. The device of claim 1, further comprising at least one sensory input device configured to record sensory information to said data storage device.

10. The device of claim 9, wherein said sensory input device is selected from the group consisting of microphones, cameras, and thermometers.

11. A method for charging a battery in a handheld wireless device and logging position data comprising the steps of:
electrically engaging an adapter with a power outlet provided in a cabin of a vehicle;
electrically engaging said adapter with a power receiving outlet provided in said handheld wireless device;
receiving global navigation satellite data and storing said data on a data storage device located within said adapter.

12. The method of claim 11, wherein said device provides an electrical current through said power receiving outlet to charge a battery in said handheld wireless device.

13. The method of claim 11, wherein said adapter further comprises a wireless network adapter.

14. The method of claim 13, wherein said wireless network adapter seeks out an available wireless network and sends data stored in said data storage device to a remote server upon connection to said wireless network.

15. The method of claim 14, wherein said seeking out of said available wireless network comprises seeking out of unsecured 802.11 wireless networks.

16. The method of claim 14, wherein said seeking out of said available wireless network comprises seeking out of only wireless devices pre-programmed into said device.

17. The method of claim 12, further comprising a step of uploading data stored on said data storage device to a server through a data connection between said handheld wireless device and a cellular network.

18. The device of claim 12, further comprising a step of seeking a data connection with a server via a wireless network adapter of said adapter and a cellular network associated with said handheld wireless device and uploading at least some data from said data storage device to said server upon establishing a data connection from said adapter to a wireless network.

19. The method of claim 14, further comprising a step of receiving data from a sensory input device and storing said data on said data storage device.

20. The device of claim 19, wherein said sensory input device is selected from the group consisting of microphones, cameras, and thermometers.
